(19) United States
(12) Patent Application Publication
(10) Pub. No.: US 2010/0137906 A1
(43) Pub. Date: Jun. 3, 2010

(54) TEXTURED STIMULUS NIPPLE

(75) Inventors: David L. Stalling, Lenexa, KS (US); Mike Litscher, Lenexa, KS (US)

Correspondence Address: SCHWEGMAN, LUNDBERG & WOESSNER, P.A., P.O. BOX 2938, MINNEAPOLIS, MN, 55402, US

(73) Assignee: KC Biomedix, Inc., Shawnee, KS (US)

(21) Appl. No.: 12/325,850

(22) Filed: Dec. 1, 2008

(51) Int. Cl. A61J 17/00

(52) U.S. Cl. 606/236

(57) ABSTRACT

A nipple comprising a bulbous portion, a tubular portion having a central axis and a first end of the tubular portion connected to the bulbous portion, the tubular portion including a texture band about an exterior surface, the texture band including a first pattern of surface features having a nominal height in a range from about 0.005 inches to about 0.022 inches, and a flange connected to a second end of the tubular portion. Some examples include nipples with a radio frequency identification (RFID) chip

### FIELD

This application is related to pacifiers and more particularly to texture nipples for non-nutritive suck entrainment therapy.

### BACKGROUND

Sucking is a precocial motor behavior in humans. However, premature infants often demonstrate oromotor dyscoordination and are unable to suck or feed orally. This inability to feed can delay discharge from neonatal intensive care units and hinder development of coordinated oromotor behavior.

Infants' readiness to feed is often evaluated by their display of non-nutritive sucking (NNS). Typically, NNS begins between 28 and 33 weeks gestational age (GA) and is remarkably stable by 34 weeks.

The brain of a typically developing fetus includes an organized set of neurons in the brainstem and cortex that are involved in the production of centrally patterned rhythmic motor behaviors. These neural circuits are known as central pattern generators or simply “CPG's”. One such rhythmic behavior that is controlled by a CPG is the suck. Under normal circumstances, the human infant is precocial for suck, which means it is a motor behavior that is established in utero and functional at birth. An infant's ability to suck at birth is important for, among other things, getting nourishment and stimulating the infant's developing brain.

In premature birth, the premature infant loses opportunities for safe neurological development in utero. This loss can be compounded by medical complications associated with premature birth, such as strokes or hemorrhages. Further, medical complications often are treated with painful procedures which correlate with impairment in neurological development. As a result of the impairment in neurological development, the premature infant may possess grossly disorganized CPG's and therefore exhibit grossly disorganized suck, which itself can lead to other medical complications and a failure to thrive and develop. Other ramifications of disorganized suck may include: ramifications relating to the infant's overall sensorimotor development, perceptual capacity, and even delays in higher cognitive function including speech, language, and other processing skills. There is a need in the art for devices to assist development of organized suck patterns in patients exhibiting disorganized suck

### SUMMARY

This application provides apparatus including a nipple comprising a bulbous portion, a tubular portion having a central axis and a first end of the tubular portion connected to the bulbous portion, wherein the tubular portion includes a micro-topology texture band about an exterior surface, and a flange connected to a second end of the tubular portion. In various embodiments, a nipple includes a radio frequency identification (RFID) chip.

This Summary is an overview of some of the teachings of the present application and is not intended to be an exclusive or exhaustive treatment of the present subject matter. Further details about the present subject matter are found in the detailed description and the appended claims. The scope of the present invention is defined by the appended claims and their equivalents.

### BRIEF DESCRIPTION OF THE DRAWINGS

FIG. 1 shows a textured pacifier nipple according to one embodiment of the present subject matter.

FIGS. 2A and 2B show partial views of a textured nipple according to one embodiment of the present subject matter.

FIG. 3 shows a textured nipple according to one embodiment of the present subject matter.

FIG. 4 shows a nipple with a radio frequency identification (RFID) chip according to one embodiment of the present subject matter.

### DETAILED DESCRIPTION

The following detailed description of the present subject matter relates to the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a tactile spatial resolution limiting sense, and the scope is defined only by the appended claims, along with the full scope of legal equivalents to which such claims are entitled.

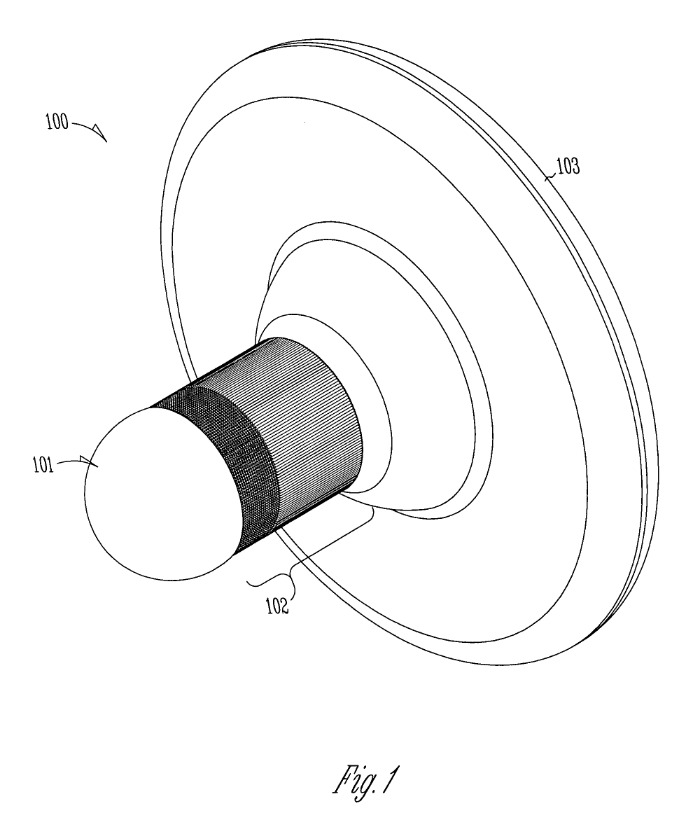

FIG. 1 shows a textured pacifier nipple 100 according to one embodiment of the present subject matter. The nipple 100 includes a bulbous end portion 101, a tubular portion 102 and a flange 103. The tubular portion 102 is connected between the bulbous end 101 and the flange 103 to create a cavity with an open end at the flange. In various embodiments, the nipple is integrated in a pacifier assembly and pneumatically coupled to a non-nutritive suck (NNS) entrainment pulse generator. In such a system, the nipple 100 functions as an expandable membrane and is made from a suitable inert elastomer such as medical grade silicone. The NNS entrainment system expands and contracts the nipple with shaped pressure pulses. For patients, such as premature infants and newborns, with poorly organized NNS function, the textured nature of the expanding and contracting nipple provides a source of vibrotactile stimulus. One's lips and fingers are very sensitive to touch and movement. In terms of amplitude, a healthy adult can detect 0.1 micron displacement at the index fingers when presented at 250 hertz. Displacement resolution is slightly larger for the lips, but still in the micron range at 50 hertz. Regimented therapy using a textured nipple and attached NNS entrainment pulse generator stimulates the lips and assists in modulating and organizing NNS as a precursor to oral feeding. The nipple embodiment 100 of FIG. 1 includes a texture band including a pattern of surface features about the exterior of the tubular region 102 near the bulbous end 101. The texture band enhances motion detection of oralfacial nerves in a patient's lips and mouth during NNS entrainment therapy. Additionally, a textured nipple enhances the transition of a premature infant or newborn to breast feeding as the texture replicates the sensation of the natural micro-topology of a mother's nipple and areola. In various embodiments, texture of the nipple includes various surface features arranged such that the space between the apex of the surface features has repeating and periodic spacing to reinforce interactions with mechanoreceptors and second- and third-order neural receptor networks present in trigeminal pathways. In various embodiments, nipple texture includes surface features with uniform height and uniform spacing. The illustrated embodiment includes nominal surface feature height of about 0.005 inches and nominal surface feature spacing of about 0.008 inches. In various embodiments, nominal uniform height of surface features range from about 0.125 mm or 0.005 inches to about 0.500 mm or 0.020 inches and nominal spacing of surface features range from about 0.200 mm or 0.008 inches to about 0.500 mm or 0.020 inches. In various embodiments, the nipple is a molded part on which the texture is imparted during injection molding.

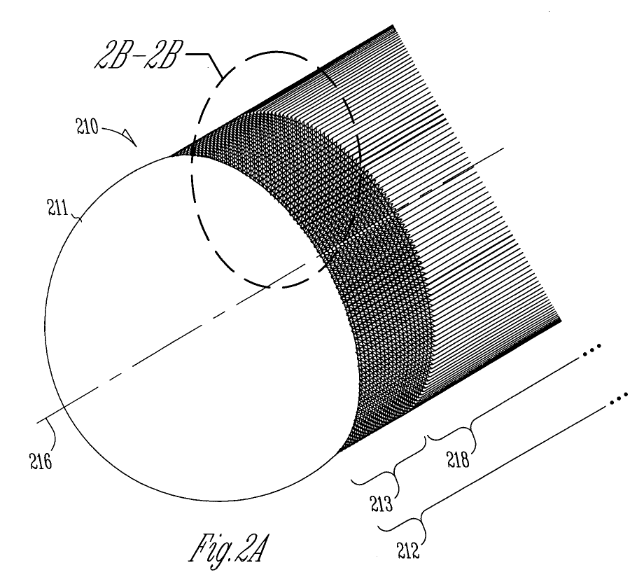

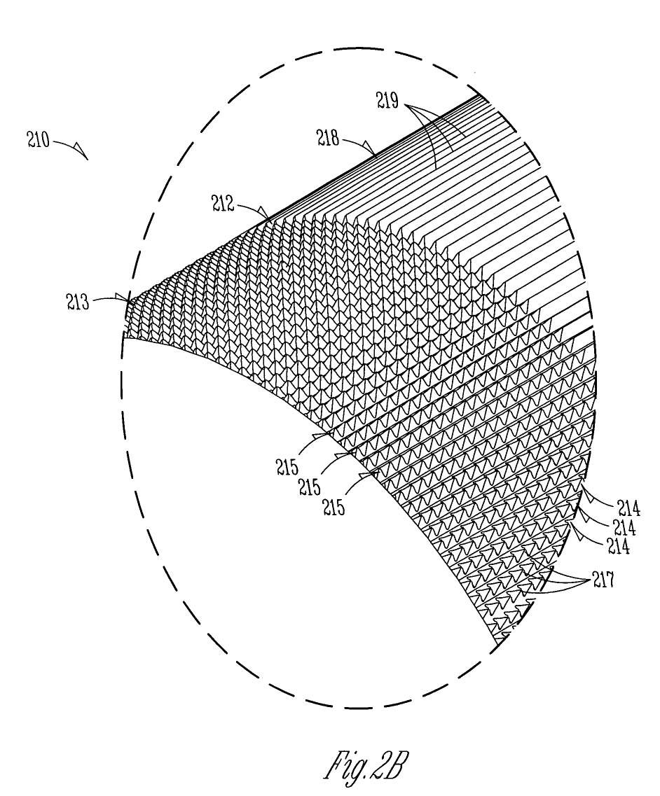

FIGS. 2A and 2B show partial views of a textured nipple 210 according to one embodiment of the present subject matter. The nipple includes a bulbous end 211, a flange (not shown) and a tubular portion 212 connecting the flange and the bulbous end 211. The exterior of the bulbous end 211 is substantially smooth. The tubular portion 212 of the nipple includes two textured portions extending sequentially from the bulbous end 211 toward the flange. The first textured portion 213 appears as a pattern including a plurality of surface features. The pattern is formed from rows 214 of surface features extending about the circumference of the exterior of the tubular portion. In various embodiments, each row 214, or ring, of the pattern includes a plurality of equally spaced surface features nodes 217. In the illustrated embodiment, the rows 214 of nodes extending about the circumference of the tubular portion are aligned to also form rows 215 of nodes extending parallel to the center axis of the tubular portion. The individual surface feature nodes 217 have a pyramid shape. In various embodiments, the surface feature nodes take the shape of domes and are derived by subtracting intersecting sine waves or continuous spline curves from the tubular portion of the nipple. It is understood that surface feature nodes of other contours, shapes, alignment and spacing are possible without departing from the scope of the present subject matter.

In various embodiments, height of the apex of each node 217 from the base is about 0.005 inches, or 125 microns. In various embodiments, the distance between closely neighboring nodes is about 0.008 inches, or 200 microns. A second textured portion 218 includes surface feature ribs 219 extending parallel to the central axis 216 of the tubular portion and equally spaced about the circumference. In various embodiments, the ribs 219 are spaced about 0.008 inches, or 200 microns, from each other. In the illustrated embodiment, the ribs have a triangular cross section. It is understood that ribs with other cross section shapes, spacing and heights are possible without departing from the present subject matter. In various embodiments, nominal uniform height of surface features range from about 0.125 mm (0.005 in.) to about 0.500 mm (0.020 in.) and nominal spacing of surface features range from about 0.200 mm (0.008 in.) to about 0.500 mm (0.020 in.).

The nipple 210 includes a bulbous end. In some embodiments, the diameter of the bulbous end 211 is greater than the diameter of the tubular portion 212 of the nipple. In various embodiments, the diameter of the tubular portion 212 is about 12 mm. and the diameter of the bulbous end 211 is about 13 mm. It is understood that other diameters and combination of diameters for the bulbous end and tubular portion of the nipple are possible without departing from the scope of the present subject matter.

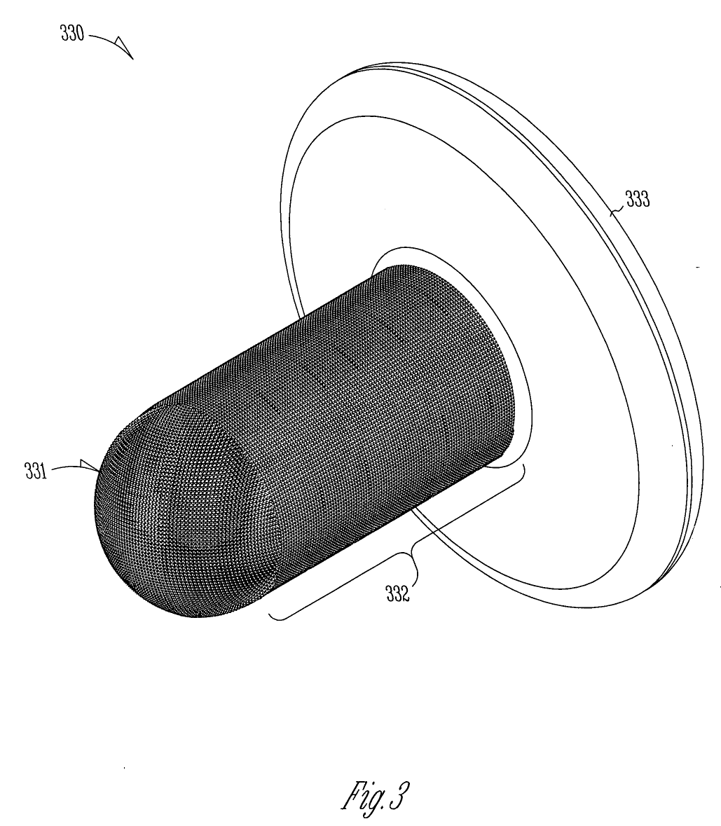

FIG. 3 shows a textured nipple 330 according to one embodiment of the present subject matter. The nipple 330 includes a bulbous end 331, a flange 333 and a tubular portion 332 connecting the bulbous end 331 to the flange 333. In various embodiments, the nipple includes texturing on the exterior surface of the bulbous end 311 and at least a portion of the exterior surface of the tubular portion 332. In the illustrated embodiment of FIG. 3, texture covers a major portion of the tubular portion of the nipple. The texture of the tubular portion includes a pattern of surface features about the exterior surface. The pattern is formed from equally spaced rows, or rings, of surface features extending about the circumference of the exterior of the tubular portion. Each row, or ring of surface features includes a plurality of individual surface features nodes. In the illustrated embodiment, the rows of nodes extending about the circumference of the tubular portion are aligned to form rows of surface features extending parallel to and about the center axis of the tubular portion. It is understood that surface features of various contours and spacing are possible without departing from the scope of the present subject matter. In various embodiments, the apex of each surface feature from the base is about 0.005 inches, or 125 microns. In various embodiments, the distance between closely neighboring surface features is about 0.008 inches, or 200 microns. In various embodiments, the nominal height of surface features in a pattern of surface feature is in a range form about 0.125 mm (0.005 in.) to about 0.500 mm (0.020 in.) and the nominal spacing of surface features in a pattern of surface features is in a range of about 0.200 mm (0.008 in.) to about 0.500 mm (0.020 in.).

The texture of the bulbous end includes a pattern of surface features about the exterior surface. The pattern is formed from rows of individual surface feature nodes extending from the distal end of the bulbous end of the nipple toward the tubular portion of the nipple. In various embodiments, the rows of nodes define a helical pattern where the rows extend about the circumference of the bulbous portion while also extending to the tubular portion. It is understood that other texture patterns and shaped texture areas are possible without departing from the scope of the present subject matter. In various embodiments, surface features are arranged such that the space between the apex of each neighboring surface feature forms a pattern of surface features to reinforce interactions with mechanoreceptors and second- and third-order neural receptor networks present in trigeminal pathways. In various embodiments, surface features within a pattern have a uniform nominal height in a range from about 0.125 mm (0.005 in.) to about 0.500 mm (0.020 in.) and uniform nominal spacing in arrange from about 0.200 mm (0.008 in.) to about 0.500 mm (0.020 in.).

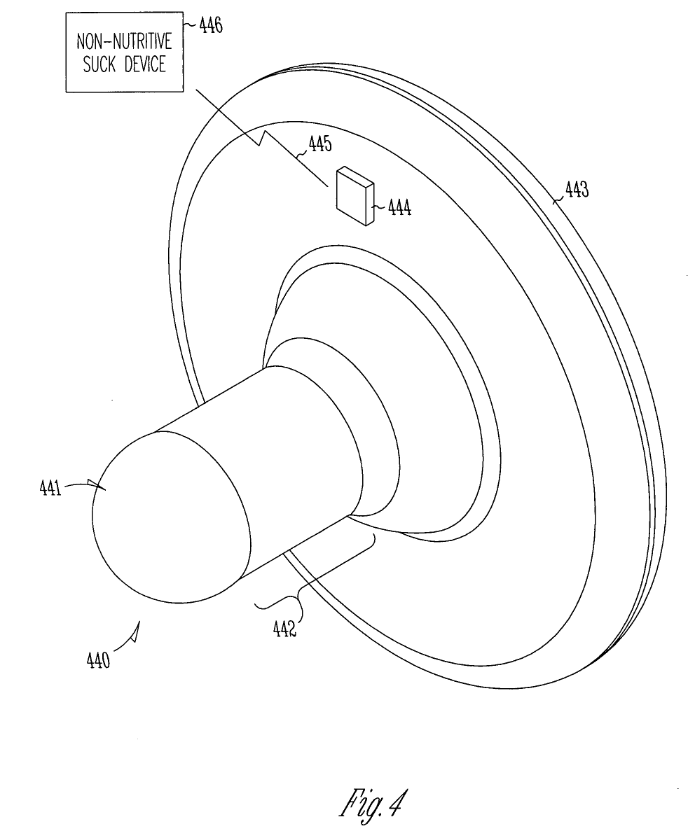

FIG. 4 shows a nipple with a radio frequency identification (RFID) chip according to one embodiment of the present subject matter. The nipple 440 includes a bulbous end 441, a flange 443 and a tubular portion 442 connecting the bulbous end 441 to the flange 443. The nipple 440 includes a RFID chip 444 attached to, inserted in or embedded in the nipple. In the illustrated embodiment, the RFID chip 444 is inserted into the flange 443 of the nipple 440. In various embodiments, RFID chip 444 includes a circuit, connected to a power source and an antenna. In some embodiments, the RFID chip is passive and does not require an internal power source. In various embodiments, power is obtained through a wireless aspect. In various embodiments, power is received via an inductive link.

In various embodiments, the RFID chip 444 is programmed with information, such as a unique code, to identify the nipple and information related to the nipple 440. For example, information related to the nipple may include, but is not limited to, the nipple manufacturer, the model of the nipple, nipple dimensions, texture patterns on the nipple, one or more unique identification codes for identifying the nipple, a patient assigned to the nipple, or combinations thereof. An example of a RFID chip for use with a nipple according to various embodiments of the present subject matter is the “μ-Chip” made by Hitachi measuring 0.05 mm×0.05 mm×5 μm thick. It is understood that nipples with other RFID chips are possible without departing from the scope of the present subject matter.

Nipples according to various embodiments of the present subject matter may be used as part of a system to sense, diagnose and/or treat non-nutritive suck (NNS). In one example, a device 446 designed for sensing, diagnosing and treating NNS includes a RFID reader to wirelessly 445 read the RFID chip 444 and collect information related to the nipple 440. The information related to the nipple may be used for a number of operational and security purposes including, but not limited to, setting operational parameters of the non-nutritive suck device, preventing improper or unauthorized use of a nipple with a NNS device or combinations thereof. For example, in various embodiments, a nipple with a RFID chip includes texture, such as discussed above, for stimulating orofacial nerves in a patient's lips and mouth during NNS entrainment therapy. Information related to the texture and to the patient is identified using a code read from the RFID chip 444. The identified information may be used to set operational parameters of a NNS device 446 related to the particular nipple and the patient's particular NNS stimulation therapy.

This application is intended to cover adaptations and variations of the present subject matter. It is to be understood that the above description is intended to be illustrative, and not restrictive. The scope of the present subject matter should be determined with reference to the appended claim, along with the full scope of equivalents to which the claims are entitled.

What is claimed is:

1. A nipple comprising:
a bulbous portion;
a tubular portion having a central axis and a first end of the tubular portion connected to the bulbous portion, the tubular portion including a texture band about an exterior surface, the texture band including a first pattern of surface features having a nominal height in a range from about 0.125 millimeters (mm) to about 0.500 mm; and
a flange connected to a second end of the tubular portion.

2. The nipple of claim 1, wherein a diameter of the bulbous portion is greater than a diameter of the tubular portion.

3. The nipple of claim 1, wherein the texture band extends from the first end of the tubular portion to the second end of the tubular portion.

4. The nipple of claim 1, wherein the first pattern of surface features include rings of surface features about the circumference of the tubular portion.

5. The nipple of claim 4, wherein each ring of surface features includes a plurality of individual surface feature nodes.

6. The nipple of claim 4, wherein the rings of surface features are separated by a nominal spacing in a range from about 0.200 mm to about 0.500 mm.

7. The nipple of claim 1, wherein the first texture band has a first end and a second end and a length of about 10 millimeters between the first end and the second end.

8. The nipple of claim 1, further comprising a second texture band about the tubular portion exterior and extending from the first texture band toward the flange, the second texture band having a second pattern of surface features, the surface features including a plurality of ribs, each rib having an apex.

9. The nipple of claim 8, wherein the plurality of ribs extend parallel to the central axis.

10. The nipple of claim 9, wherein each rib has a uniform height in a range from about 0.125 mm to about 0.500 mm.

11. The nipple of claim 10, wherein the apex of neighboring surface feature ribs are separated by a uniform distance in a range from about 0.200 mm to about 0.500 mm.

12. The nipple of claim 8, wherein the bulbous portion includes a third pattern of surface features.

13. The nipple of claim 12, wherein the third pattern of surface features includes rows of surface features extending from a distal end of the bulbous portion to the tubular portion.

14. The nipple of claim 13, wherein each row of surface features of the third pattern of surface features extends from the distal end of the bulbous portion according to a helical path toward the tubular portion.

15. The nipple of claim 1, further comprising a pacifier attachment coupled to the flange and adapted to pneumatically couple the nipple to a non-nutritive suck entrainment device.

16. The nipple of claim 1, further comprising a radio frequency identification (RFID) chip coupled to the nipple.

17. A nipple comprising:
a bulbous portion having a first pattern of surface features, each surface feature of the first pattern of surface features having a uniform height in a range from about 0.125 millimeters (mm) to about 0.500 mm;
a tubular portion having a first end connected to the bulbous portion, wherein the tubular portion includes a texture band about an exterior surface, the texture band having a second pattern of surface features; and
a flange connected to a second end of the tubular portion.

18. The nipple of claim 17, wherein the first pattern of surface features includes rows of surface feature nodes extending from a distal end of the bulbous portion to the tubular portion.

19. The nipple of claim 18, wherein each row of the first pattern of surface feature extends from the distal end of the bulbous portion according to a helical path toward the tubular portion.

20. The nipple of claim 19, further comprising a radio frequency identification (RFID) chip coupled to the nipple.
